(19) United States
(12) Patent Application Publication
(10) Pub. No.: US 2024/0210990 A1
(43) Pub. Date: Jun. 27, 2024

(54) ELECTRONIC DEVICE

(71) Applicant: Apple Inc., Cupertino, CA (US)

(72) Inventors: Keith J. Hendren, San Francisco, CA (US); Christiaan A. Ligtenberg, San Carlos, CA (US); Ari P. Miller, San Francisco, CA (US); Nicholas Alan Rundle, San Jose, CA (US); Dinesh C. Mathew, San Francisco, CA (US); Simon J. Trivett, Waterloo (CA); Ron A. Hopkinson, Campbell, CA (US); Michael E. Leclerc, Mountain View, CA (US)

(21) Appl. No.: 18/534,452

(22) Filed: Dec. 8, 2023

Related U.S. Application Data
(60) Provisional application No. 63/434,811, filed on Dec. 22, 2022.

(51) Int. Cl. G06F 1/16; G06F 1/18

(52) U.S. Cl. CPC G06F 1/1616; G06F 1/1607; G06F 1/1673; G06F 1/1681; G06F 1/1686; G06F 1/183

(57) ABSTRACT

A laptop computer may include a lid portion including a housing structure, a glass cover positioned coupled to the housing structure and defining a concave region, and a display positioned below the concave region of the glass cover. The laptop computer may also include a base portion positionable in a closed configuration and an open configuration with respect to the lid portion and defining a convex region along a top side of the base portion, the convex region configured to extend into the concave region of the glass cover when the lid portion and the base portion is in the closed configuration, the base portion including a keyboard positioned at the convex region.

### CROSS-REFERENCE TO RELATED APPLICATION(S)

This application is a nonprovisional patent application of and claims the benefit of U.S. Provisional Patent Application No. 63/434,811, filed Dec. 22, 2022 and titled “Electronic Device,” the disclosure of which is hereby incorporated herein by reference in its entirety.

### FIELD

The subject matter of this disclosure relates generally to electronic devices, and more particularly, to portable electronic devices such as laptop computers.

### BACKGROUND

Modem consumer electronic devices take many shapes and forms and have numerous uses and functions. Laptop computers, for example, are common types of computers that provide computing functions in a lightweight, portable form factor. Laptop computers may include input devices, such as keyboards and trackpads, and may have displays to produce graphical outputs.

### SUMMARY

A laptop computer may include a lid portion including a housing structure, a glass cover positioned coupled to the housing structure and defining a concave region, and a display positioned below the concave region of the glass cover. The laptop computer may also include a base portion positionable in a closed configuration and an open configuration with respect to the lid portion and defining a convex region along a top side of the base portion, the convex region configured to extend into the concave region of the glass cover when the lid portion and the base portion are in the closed configuration, the base portion including a keyboard positioned at the convex region.

The glass cover may be a unitary glass structure, the lid portion may be coupled to the base portion by a hinge, the keyboard may include a plurality of physical keys, and the base portion may further include a trackpad positioned at the convex region.

The concave region may define a display region of the lid portion, and the glass cover may further define a bezel region extending around a periphery of the display region, and a curved transition region extending from the bezel region to the display region. The curved transition region may be a first curved transition region, and the base portion may include a top member defining the convex region, a peripheral region extending around a periphery of the convex region, and a second curved transition region extending from the peripheral region to the convex region.

The base portion may include a glass top member, and the glass top member may at least partially define the convex region. The glass top member may define, at the convex region, a trackpad. The glass top member may further define, at the convex region, a virtual keyboard.

A portable computing device may include a lid portion including a housing structure, a unitary glass cover coupled to the housing structure and defining a bezel region and a recessed region at least partially surrounded by the bezel region, and a display positioned below the recessed region. The portable computing device may further include a base portion flexibly coupled to the lid portion and including a keyboard protruding from a top surface of the base portion and configured to extend into the recessed region when the lid portion and the base portion are in a closed configuration, and a trackpad protruding from the top surface of the base portion and configured to extend into the recessed region when the lid portion and the base portion are in the closed configuration.

The lid portion may be coupled to the base portion via a hinge mechanism positioned along a bottom side of the lid portion and a back side of the base portion, and the portable computing device may further include a first circuit board assembly in the lid portion and positioned between the recessed region and the hinge mechanism, and a second circuit board assembly in the base portion and positioned between the keyboard and the hinge mechanism.

The first circuit board assembly may be non-overlapping with an active area of the display. The second circuit board assembly may be non-overlapping with the keyboard.

The base portion may include a unitary glass top member, the keyboard may be a virtual keyboard, and the unitary glass top member may define a surface of the virtual keyboard and a surface of the trackpad.

The bezel region may be opaque, and the recessed region may be transparent. The portable computing device may further include an opaque mask positioned in the bezel region along an interior surface of the unitary glass cover.

A portable computing device may include a lid portion including a housing, a display at least partially within the housing, and a unitary glass cover positioned over the display and defining a bezel region extending at least partially around an active area of the display and a recessed display region recessed relative to the bezel region and positioned over the active area of the display. The lid portion may further include a circuit board assembly positioned below a portion of the bezel region and conductively coupled to the display. The portable computing device may further include a base portion flexibly coupled to the lid portion and including a keyboard protruding from a top surface of the base portion and configured to extend into the recessed display region when the lid portion and the base portion are in a closed configuration.

The lid portion may further include a touch sensing system configured to detect touch inputs applied to the recessed display region and at least a portion of the bezel region. The portable computing device may further include a camera positioned in the bezel region.

The circuit board assembly may be a first circuit board assembly, and the base portion may include a second circuit board assembly conductively coupled to the first circuit board assembly. The base portion may be flexibly coupled to the lid portion via a hinge mechanism positioned along a bottom of the lid portion and a back of the base portion, and the second circuit board assembly may be positioned within the base portion between the keyboard and the hinge mechanism. The keyboard may be positioned in a keyboard region of the base portion, the first circuit board assembly may be positioned entirely outside the recessed display region, and the second circuit board assembly may be positioned entirely outside the keyboard region.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1C depict an example electronic device;

FIG. 2A depicts an exploded view of a portion of the electronic device of FIGS. 1A-1C;

FIG. 2B depicts a partial cross-sectional view of a front cover of the electronic device of FIGS. 1A-1C;

FIG. 3A-3C depict partial cross-sectional views of the device of FIGS. 1A-1C;

FIGS. 4A-4C depict partial cross-sectional views of front covers for use with an electronic device;

FIG. 5 is a partial exploded view of a lid portion of another example electronic device;

FIGS. 6A-6B depict partial cross-sectional views of another example electronic device;

FIGS. 7A-7B depict portions of another example electronic device;

FIG. 7C depicts a partial cross-sectional view of the electronic device of FIGS. 7A-7B;

FIG. 8A depicts a partial cross-sectional view of another example electronic device;

FIGS. 8B-8C depict partial cross-sectional views of another example electronic device; and

FIG. 9 depicts a schematic diagram of an example electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Laptop computers as described herein include a base portion, which includes input devices such as a keyboard, trackpad, and the like, and a lid portion that is flexibly coupled to the base portion (e.g., via a hinge mechanism). The lid portion includes a display, which may be a touch- and/or force-sensitive display and may include a camera for capturing images (e.g., still or video images) of a user, such as for videoconferencing purposes. Both the base portion and the display or “lid” portion may include circuit board assemblies to which various electrical systems are coupled. For example, the lid portion may include a first circuit board assembly to which the display, the front-facing camera, touch sensors (if equipped), and other lid-mounted electrical systems may be coupled. Similarly, the base portion may include a second circuit board assembly to which the keyboard, the trackpad, memory, processors, input/output ports, and other base-mounted electrical systems may be coupled. The overall arrangement of these (and other) components and systems within the base and lid portions may affect the overall size and shape of the laptop.

Because laptop computers are typically portable computing devices, factors such as size, weight, and durability can affect the overall usefulness of the device. In many cases, it is advantageous for laptops to be very thin when they are in a closed configuration so that they are easily stored and transported. However, reducing the thickness of a laptop may not be preferred if it results in other dimensions becoming larger.

Described herein are configurations for a laptop computer that result in reduced thicknesses in the closed configuration, without significantly increasing the other dimensions of the laptop. For example, a lid portion of a laptop computer may be provided with a front cover that is formed of a shaped glass sheet. In some cases, the shaped glass sheet defines a concave region formed generally into the middle of the sheet and is generally surrounded by a non-recessed region of the glass. The concave region is positioned over the display, while the non-recessed region of the glass defines a border around the display. The concave region of the glass cover defines an area into which components on the base portion may extend when the laptop is closed. For example, when the laptop is closed, a keyboard and trackpad, which may sit proud of the upper surface of the base portion, may extend into the concave region of the shaped glass cover, such that the keyboard and the trackpad are effectively nested with the shaped glass cover.

The nesting arrangement of the base portion and the lid portion reduces the thickness of the laptop when it is closed, while also providing convenient space in the lid portion for other non-display components. For example, the non-recessed region of the glass around the concave region may define a larger volume in which components such as a circuit board assembly and/or a camera may be positioned. Moreover, by positioning these components in the non-recessed region that is outside of the display region, they do not need to be stacked behind the display, further reducing the overall thickness of the device.

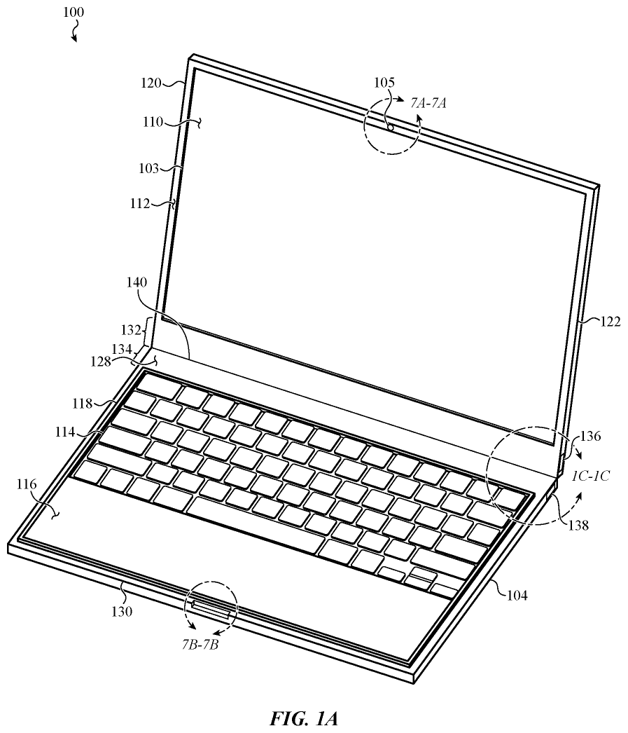

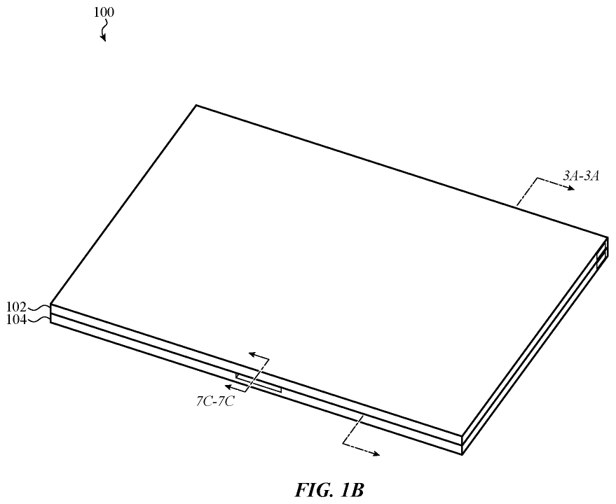

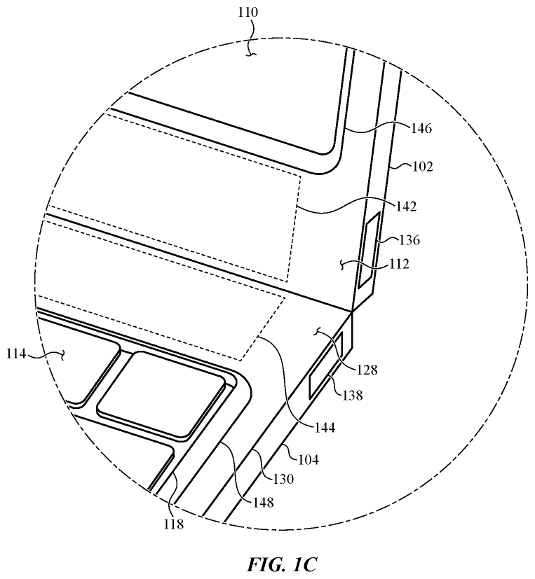

FIGS. 1A-1B depict a computing device 100 (or simply “device 100”). FIG. 1A illustrates the device 100 in an open configuration, and FIG. 1B illustrates the device in a closed configuration. The device 100 may be or may resemble a portable computer, also known as a laptop or notebook computer or portable computing device, that has a lid portion 102 and a base portion 104 flexibly or pivotally coupled to the lid portion 102 (e.g., so that the lid portion 102 is able to rotate, pivot, flex, articulate, or otherwise move relative to the base portion 104). The lid portion 102 and the base portion 104 may be coupled via a hinge mechanism 140. The hinge mechanism 140 may couple the lid portion 102 to the base portion 104 and allow the lid portion 102 to be positioned in an open configuration relative to the base portion (FIG. 1A), and a closed configuration relative to the base portion (FIG. 1B). The hinge mechanism 140 may also provide channels through which electrical connectors may pass to conductively couple components of the lid portion 102 to components of the base portion 104.

The lid portion 102 includes a display 103 that provides a primary means of conveying visual information to the user, such as by displaying graphical user interfaces. The lid portion 102 also includes a camera 105. The camera 105 may capture images (e.g., still and/or video images), such as for videoconferencing functions, general image capture/recording, or the like.

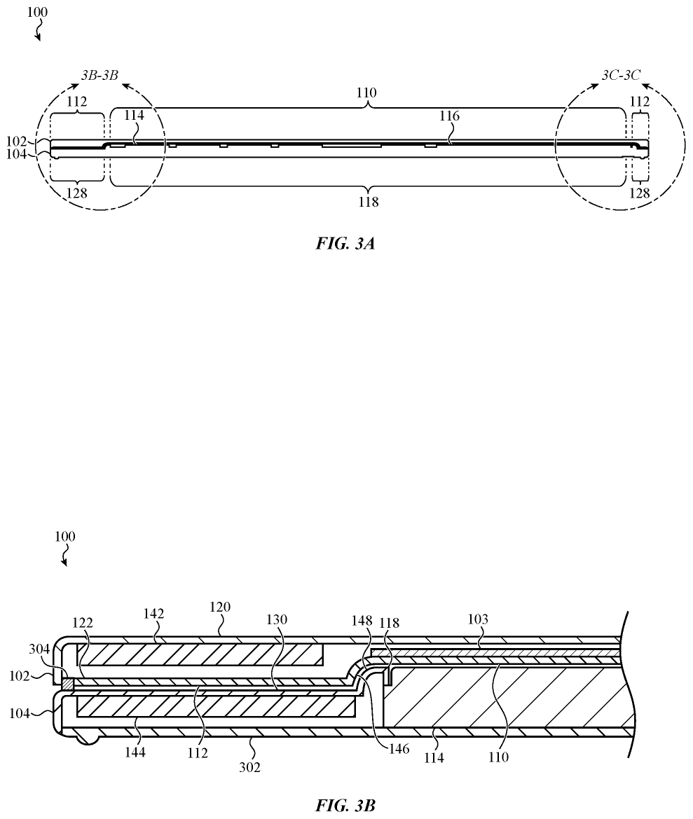

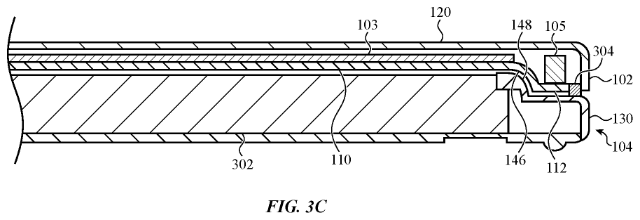

The base portion 104 is positionable in a closed configuration and an open configuration with respect to the lid portion 102. The base portion 104 may include a top member 130 and a bottom member 302 (FIG. 3B) coupled to the top member 130. The top member 130 may at least partially define a top surface of the base portion 104, and the bottom member 302 may define a bottom surface of the base portion 104. The top member 130 may be formed from or include metal, polymers, glass, ceramic, glass-ceramic, crystallizable glass materials, or other suitable materials. The bottom member 302 may also be formed from or include metal, polymers, glass, ceramic, glass-ceramic, crystallizable glass materials, or other suitable materials.

The base portion 104 may include a keyboard 114 and a trackpad 116. The keyboard 114 may be any type of keyboard that can receive typing inputs. For example, the keyboard 114 may be a keyboard with moving keys (e.g., movable keycaps supported by a key mechanism such as a scissor mechanism). As another example, the keyboard 114 may be a virtual keyboard, such as a keyboard that is displayed on a touch-sensitive input surface (e.g., a touchscreen). In the case of a virtual keyboard, the keyboard may include a glass or other transparent upper cover member that defines the input surface of the keyboard. Other types of keyboards may also be used.

The trackpad 116 may be configured to detect touch- and/or force-based inputs applied to the base portion 104 to the trackpad 116. For example, the trackpad 116 may detect clicks, taps, gestures (e.g., swiping, pinching), multi-touch inputs, and the like. While FIG. 1A illustrates one example shape, size, and location of a trackpad 116, other configurations are also possible. For example, the trackpad 116 may be larger or smaller than that shown in FIG. 1A. In some cases, the trackpad 116 may include substantially the entire region of the upper surface of the base portion 104 other than the keyboard 114.

The keyboard 114 and the trackpad 116 may be separate components from the top member 130 of the base portion 104. For example, the top member 130 may define one or more holes in which the keyboard 114 and/or the trackpad 116 are positioned. In some cases, one or both of the keyboard 114 or the trackpad 116 may be defined by the top member itself. For example, in cases where the top member 130 is formed from a non-conductive material (or is otherwise capable of defining a touch-sensitive input surface), the surface of the keyboard 114 and/or the trackpad 116 may be defined by the top member 130 itself. Where the top member 130 is transparent, a display may be positioned under the keyboard or trackpad regions to display graphical outputs such as trackpad boundaries, keyboard keys, and the like. In some cases, the top member 130 is formed from a glass structure, and the surface of one or both of the keyboard 114 and the trackpad 116 may be defined by the top member 130. For example, the top member 130 may define a glass top surface, and a touch- and/or force-sensitive region of the glass top surface may define the keyboard 114 and/or the trackpad 116.

The lid portion 102 may include a housing structure 120 and a front cover 122. The housing structure 120 may be formed from metal and may define a back or top exterior side of the lid portion 102, as well as peripheral sides of the lid portion 102. The front cover 122, which may be part of a front cover assembly as described herein, may define at least a portion of the front exterior surface of the lid portion 102.

In some cases, the front cover 122 is formed from or includes a glass material and may therefore be referred to as a glass cover or glass front cover. The glass material may be a silica-based glass material, an aluminosilicate glass, a boroaluminosilicate glass, an alkali metal aluminosilicate glass (e.g., a lithium aluminosilicate glass), or a chemically strengthened glass. Other example materials for the front cover 122 include, without limitation, sapphire, ceramic, glass-ceramic, crystallizable glass materials, or plastic (e.g., polycarbonate). A glass-ceramic material may be a silica-based glass ceramic material, such as an aluminosilicate glass ceramic material or a boroaluminosilicate glass ceramic material. The glass-ceramic material may be chemically strengthened by ion exchange. The front cover 122 may be formed as a monolithic or unitary sheet. The front cover 122 may also be formed as a composite of multiple layers or multiple segments of different materials, coatings, and other elements.

The front cover 122 may define a concave region 110 and a bezel region 112 that extends around a periphery of the concave region 110 (and thus around the display 103). In some cases, the bezel region extends along less than all of the periphery of the concave region 110 (e.g., the bezel region defined by the front cover 122 may extend along only a top and bottom side of the concave region 110, or along only a left and right side of the concave region 110). In some cases, the concave region 110 defines the display region of the lid portion 102 (e.g., the region corresponding to the active area of the display 103). The concave region 110 may be recessed relative to the bezel region, and may also be referred to as a recessed region.

As shown and described herein, the bezel region 112 may define an area with a larger internal volume in the lid portion 102 as compared to the concave region 110. As such, the bezel region 112 may accommodate components that are thicker than the display 103. Further, the bezel region 112 and the concave region 110 are configured to generally conform to the thickness of the components that they cover, thereby reducing wasted or unused space in the device 100.

The concave (or recessed) region 110 of the lid portion 102 may be configured to receive or “nest” with a convex region of the base portion 104. For example, the base portion 104 includes a convex region 118 along a top side of the base portion 104, and the convex region is configured to extend into the concave region 110 of the glass cover when the lid portion 102 and the base portion 104 are in the closed configuration. The convex region 118 may include the keyboard 114 and the trackpad 116, and may extend from or sit proud of a peripheral region 128 of the base portion 104. In some cases, the top member 130 at least partially defines the raised, convex region of the base portion 104, as described herein.

The keyboard 114 and trackpad 116 may be positioned in (or define) the convex region 118. For example, the keyboard 114 and/or the trackpad 116 are proud of the peripheral region 128 (e.g., extend higher than the peripheral region 128). In examples where the keyboard 114 and/or the trackpad 116 are separate components from the top member 130 of the base portion 104, the keyboard 114 and/or trackpad 116 are coupled to the base portion 104 such that they extend above the peripheral region 128 (e.g., the keyboard 114 and/or the trackpad 116 may protrude above a top surface of the top member 130). In examples where the surfaces of the keyboard 114 and/or the trackpad 116 are defined by the top member 130 (e.g., where the top member 130 is glass), the top member 130 may define a protrusion that corresponds to the convex region, and the keyboard 114 and/or the trackpad 116 may be defined by the surface of the top member 130 in the convex region. In some cases, the top member may define a single continuous surface along the convex region, and the keyboard 114 and the trackpad 116 may be defined by regions of the continuous surface.

As described herein, the device 100 may be configured to avoid or reduce overlapping of internal components in order to achieve a low overall thickness (e.g., in the closed configuration). For example, circuit board assemblies in the lid portion 102 and the base portion 104 may be arranged in a non-overlapping configuration with the display 103 and the keyboard 114, respectively (e.g., the circuit board assembly of the lid portion 102 may be positioned entirely outside the concave or recessed display region, and the circuit board assembly of the base portion 104 may be positioned entirely outside the keyboard region).

As described herein, a first circuit board 142 (FIG. 1C) assembly of the lid portion 102 may be positioned in a circuit board region 132 of the lid portion 102, and a second circuit board assembly 144 (FIG. 1C) may be positioned in a circuit board region 134 of the base portion 104. The circuit board region 132 may correspond to part of the bezel region 112 defined by the front cover 122 (e.g., a portion of the bezel region along a bottom side of the concave region 110), and may be positioned between the display 103 and the hinge mechanism 140. Because the bezel region 112 is raised relative to the concave region 110, the first circuit board assembly can be positioned in the lid portion 102 without increasing the thickness in the concave region 110 or otherwise requiring space in the lid portion 102 for a stack that includes both the display and the first circuit board assembly. Similarly, the circuit board region 134 may correspond to part of the peripheral region 128 around the convex region 118 (e.g., a portion of the surrounding region along a top of the keyboard 114) and may be positioned between the convex region 118 and the hinge mechanism 140. Because the circuit board region 134 is outside of the keyboard region, the second circuit board assembly can be positioned in the base portion 104 without requiring space in the base portion for a stack that includes both the keyboard 114 and the second circuit assembly.

The device 100 may also include ports, such as ports 136 and 138. The port 136 may be positioned along a side of the lid portion 102 and may be conductively coupled to the first circuit board assembly in the first circuit board region 132. The port 138 may be positioned along a side of the base portion 104 and may be conductively coupled to the second circuit board assembly in the second circuit board region 134. The ports 136, 138 may facilitate the connection of power cables, charging cables, input/output cables or components, or the like.

FIG. 1C is a detail view of area 1C-1C in FIG. 1A, illustrating further detail of the structure of the front cover 122 and the top member 130 according to an example implementation. As shown, the front cover 122 defines a curved transition region 146 that extends from the bezel region 112 to the concave region 110. As described herein, the top member 130 may be formed from a unitary glass sheet to form a unitary glass top member (or unitary glass cover). The unitary glass sheet may be molded (e.g., slumped) to define the bezel region 112, concave region 110, and the curved transition region 146 (e.g., the unitary glass cover). In such cases, the glass sheet may define a substantially continuous exterior surface that extends smoothly (e.g., without sharp edges or gaps) from the outer edge of the sheet, along the bezel region 112, the curved transition region 146, and the concave region 110.

In some cases, the top member 130 of the base portion 104 defines a curved transition region 148 that extends from the peripheral region 128 and at least partially defines or surrounds the convex region 118. As described herein, the top member 130 may be formed from a unitary sheet which may be formed (e.g., machined, molded, slumped) to define the peripheral region 128, the convex region 118, and the curved transition region 148. The top member 130 may be formed of glass, metal (e.g., aluminum, stainless steel, titanium), a polymer, or the like.

As described herein, the shapes and positions of the various features of the top member 130 and the front cover 122 may be complementary, such that the convex region 118 of the base portion 104 and the concave region 110 of the front cover 122 nest with one another to provide a close-fitting arrangement of the lid portion 102 and the base portion 104.

FIG. 1C also illustrates the relative positioning of the first and second circuit board assemblies 142, 144 in the lid portion 102 and the base portion 104, respectively. For example, the first circuit board assembly 142 is positioned below part of the shaped glass front cover 122 that defines the bezel region (e.g., between the display 103 and the hinge mechanism 140, FIG. 1A), while the display 103 (FIG. 1A) is positioned below part of the shaped glass front cover 122 that defines the recessed or concave region 110. Similarly, the second circuit board assembly 144 is positioned below part of the top member 130 that defines the peripheral region 128 (e.g., between the keyboard 114 and the hinge mechanism 140, FIG. 1A), while the keyboard 114 (FIG. 1A) is positioned within the convex region 118 (and/or at least partially defines the convex region 118).

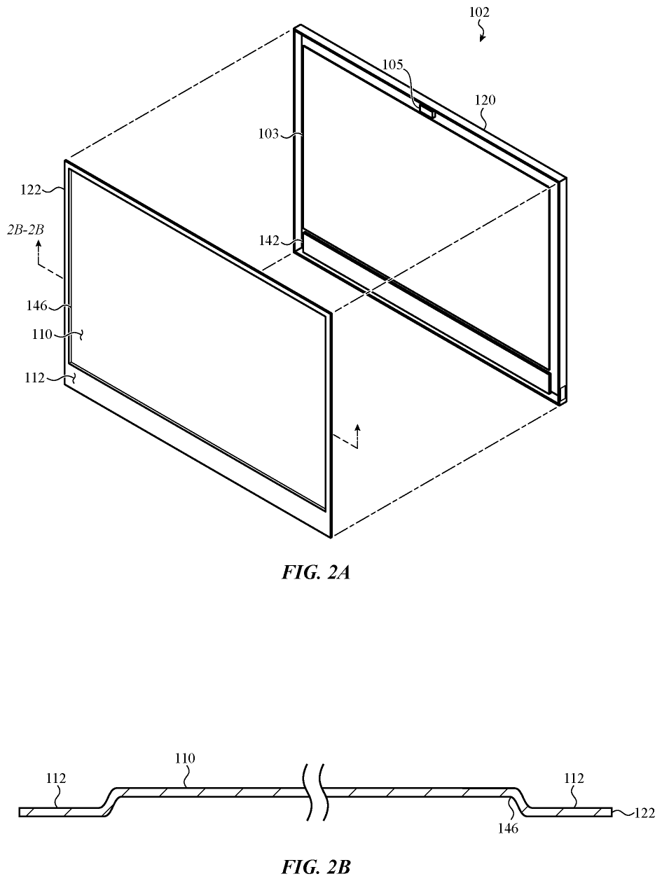

FIG. 2A is a partial exploded view of the lid portion 102, showing the front cover 122 separate from the housing structure 120. FIG. 2A illustrates an example position of the display 103 within the housing structure 120 and below the concave region 110 of the front cover 122. FIG. 2A also illustrates an example position of the first circuit board assembly 142, below the bezel region 112 along a bottom side of the display 103. As illustrated in FIG. 2A, the first circuit board assembly 142 and the display 103 are in a non-overlapping configuration, allowing the front cover 122 to generally conform to the minimum achievable thickness at each location. Thus, the concave configuration of the front cover 122 reduces empty (and thus wasted) internal volume that may be present if the front cover 122 did not define the concave configuration (e.g., if it were simply a planar sheet. While FIG. 2A illustrates the display 103 and the circuit board assembly 142 in the housing structure 120, it will be understood that these components may be coupled to either the housing structure 120, the front cover 122, or both. In one example, the circuit board assembly 142 is coupled to the housing structure (e.g., via fasteners, adhesives, etc.), and the display 103 is coupled to the front cover 122 (e.g., via an optically clear adhesive that adheres the display 103 to the interior surface of the front cover 122.

FIG. 2B depicts a partial cross-sectional view of the front cover 122, viewed along line 2B-2B in FIG. 2A, illustrating an example shape of the front cover 122. As shown in this example, the front cover 122 is a unitary sheet, such as a unitary glass sheet, that is molded or otherwise formed to define the concave or recessed region 110, the bezel region 112, and the curved transition region 146. The molding process may result in the exterior surface of the front cover 122 (e.g., the bottom surface as oriented in FIG. 2B) defining a smooth, continuous surface, with the curved transition region 146 having curved profiles (e.g., without sharp or discontinuous edges or seams). Moreover, the thickness of the front cover 122 may be substantially the same along the bezel region 112, the curved transition region 146, and the concave region 110.

The front cover 122 may be formed by molding the glass using a slumping operation (or any other suitable molding technique). For example, a sheet of glass (e.g., a planar sheet of glass) may be placed on a mold. The sheet of glass may be pre-heated, or it may be heated once in contact with the mold (e.g., by placing the mold and sheet in a kiln or furnace). The heat softens the glass such that the glass conforms to the shape of the mold. The glass may conform to the mold due to gravity. The mold may contact either surface of the glass sheet (e.g., the interior or the exterior surface of the front cover 122). In some cases, a two-part mold may contact both surfaces of the sheet. In such cases, a force may be applied to the glass sheet via the mold parts (e.g., due to the weight of the upper mold part pressing on the lower mold part, or due to a force applied to the mold parts via an actuator, press, or the like).

After being molded or otherwise formed to produce the concave configuration, the front cover 122 may be subjected to further processing and/or finishing steps. For example, the front cover 122 may be thermally and/or chemically strengthened, polished, singulated (e.g., from a mother sheet), machined, lapped, tinted, coated, or the like.

The non-planar overall shape of the front cover 122 may also enhance the stiffness of the lid portion 102 as compared to a planar front cover. For example, the concave shape of the front cover 122 has a greater area moment of inertia than a planar front cover, and thus has a greater resistance to certain deflections and/or deformations (e.g., bending or twisting) than a planar front cover. Accordingly, the shaped front cover 122 facilitates a reduction in the overall thickness of the device, while also offering a high degree of resistance to bending, twisting, or other deformations that could damage internal components or otherwise lead to a weaker and less durable device.

FIG. 3A depicts a partial cross-sectional view of the device 100, viewed along line 3A-3A in FIG. 1B. FIG. 3B illustrates how the convex configuration of the base portion 104 nests with the concave configuration of the lid portion 102. In particular, the convex region 118 of the base portion 104, which includes the keyboard 114 and the trackpad 116, defines a complementary shape to the concave region 110 of the front cover of the lid portion 102 and extends into the concave region 110. In some cases, the distance between the lid portion 102 and the base portion 104 along the facing surfaces is substantially equal along the entire profile. Thus, for example, the distance between the bezel region 112 and the peripheral region 128 (when the device 100 is in the closed configuration) may be substantially the same as the distance between the concave region 110 and the convex region 118 (e.g., an upper surface of a key of the keyboard 114 and/or an upper surface of the trackpad 116). The distance between the curved transition regions 146, 148 may also be substantially the same as the distances between the bezel and peripheral regions and the convex and concave regions.

FIG. 3B depicts a detail view of area 3B-3B in FIG. 3A, showing an example configuration of the concave and convex regions proximate a back side of the device 100 (e.g., where the lid portion 102 is flexibly coupled to the base portion 104 via the hinge mechanism 140, FIG. 1A), as well as an example arrangement of internal components of the device 100. FIG. 3B illustrates how the nesting configuration of the front cover 122 and the base portion 104 accommodate various internal components while minimizing or reducing the overall thickness of the device 100. In particular, FIG. 3B illustrates how the first circuit board assembly 142 is positioned outside the outer periphery of the display 103 (e.g., does not overlap with the display 103) and the second circuit board assembly 144 is positioned outside the outer periphery of the keyboard 114 (e.g., does not overlap with the keyboard 114). Because these components do not overlap, the minimum achievable thickness of the device 100 is reduced, as the device does not need to accommodate the added thickness of the overlapping components.

Furthermore, because the first circuit board assembly 142 does not overlap the display 103, the lid portion 102, and because the front cover is shaped to conform to the different thicknesses of the lid-mounted components, the lid portion 102 can be made very thin in the display region. In some cases, there are no additional components between the display 103 and the inside surface of the housing structure 120 of the lid portion 102, such that the gap between the inside surfaces of the front cover 122 and the housing structure 120 in the display region can be almost as thin as the display 103 itself. In some cases, the display 103 is adhered to both the inside surfaces of the front cover 122 and the housing structure 120.

FIG. 3C depicts a detail view of area 3C-3C in FIG. 3A, showing an example configuration of the concave and convex regions proximate a front side of the device 100 (e.g., where the top of the lid portion 102 closes against the trackpad 116), as well as an example arrangement of internal components of the device 100 in this region. FIG. 3C further illustrates how the nesting configuration of the front cover 122 and the base portion 104 accommodate various internal components while minimizing or reducing the overall thickness of the device 100. In particular, FIG. 3C illustrates how the camera 105 is positioned outside the outer periphery of the display 103 (e.g., does not overlap with the display 103) and within the bezel region 112 where the front cover 122 is not recessed. Additionally, the trackpad 116 may be within (and/or may at least partially define) the convex region 118 of the base portion 104. As such, the trackpad 116 may nest with the concave region 110 of the front cover 122, and the bezel region 112 (which defines an increased thickness to provide space for the camera 105) nests with the peripheral region 128 of the base portion 104.

As shown in FIGS. 3A-3C, the concave and convex configurations of the front cover 122 and the base portion 104, respectively, generally conform to the size (e.g., thickness) of the components in the lid portion 102 and the base portion 104. For example, in the lid portion 102, the front cover 122 is recessed in the area over the display 103 in order to take advantage of the relative thinness of the display 103, while the bezel region 112 of the front cover 122 (e.g., which is proud of the recessed concave region 110) to provide sufficient room for the thicker circuit board assembly 142. In a complementary fashion, the keyboard 114 (and the trackpad 116) is thicker than the circuit board assembly 144, and as such the base portion 104 defines a convex region that includes the keyboard 114 and the trackpad 116 and which extends into the recessed region of the front cover 122. The circuit board assembly 144, which may be thinner than the keyboard and trackpad, is positioned in the peripheral region 128 that is recessed relative to the convex region 118. Accordingly, the device can use the shaped front cover 122 and the structure of the base portion 104 to exploit the positioning of the components (e.g., in which thicker components in the lid portion 102 are directly over thinner components in the base portion 104, and vice versa) to reduce the overall thickness of the device and eliminate or reduce wasted space.

In some cases, the device 100 may include a barrier member 304 to prevent or inhibit contact between the front cover 122 and the base portion 104 when the device 100 is in the closed configuration. The barrier member 304 may be or may include a polymer material (e.g., an elastomeric polymer material) that extends completely or partially around the outer periphery of the front cover 122 and extends proud of the front cover 122. The barrier member 304 may thus contact the base portion 104 when the device 100 is in the closed configuration, and may define an air gap between the front cover 122 and the base portion 104. In some cases, the barrier member 304 is positioned in a gap that is defined between the front cover 122 and the housing structure 120, and may be retained in position using mechanical interlocks, adhesives, or any other suitable retention technique.

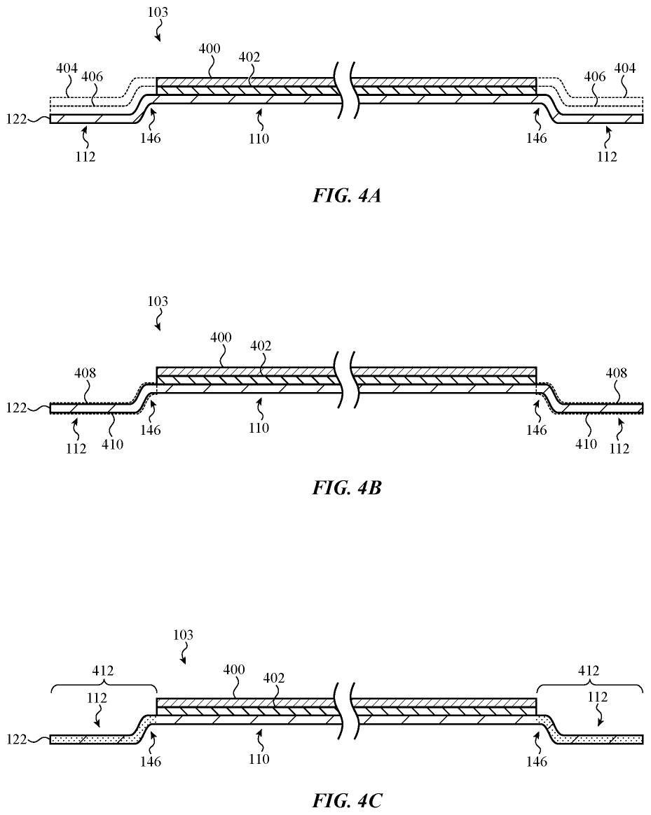

As described herein, the front cover 122 may be formed from a single piece of transparent glass (e.g., a unitary glass structure). In such cases, the concave region 110, as well as the curved transition region 146 and the bezel region 112, are transparent and non-conductive, such that any of these regions may be provided with a display and/or touch-sensing capabilities. FIG. 4A depicts a partial cross-sectional view of the front cover 122 and the display 103 (shown as a touch-sensitive display). The display 103 may include a display element 400 (which may include multiple sub-layers) to produce graphical outputs, and a touch-sensitive element 402 (which may include multiple sub-layers) to detect touch inputs applied to the front cover 122. In one example configuration, the display 103 is positioned behind the concave region 110 and does not extend along the curved transition region 146 or the bezel region 112 (e.g., the concave region 110 defines the graphically active region and the touch-sensitive region of the display).

In some cases, one or both of the display element 400 or the touch-sensitive element 402 may extend along at least a portion of the curved transition region 146 or along both the curved transition region 146 and at least a portion of the bezel region 112. For example, FIG. 4A illustrates an extended potion 404 of the display element 400 extending along the curved transition region 146 and the bezel region 112, and an extended portion 406 of the touch-sensitive element 402 extending along the curved transition region 146 and at least a portion of the bezel region 112. While FIG. 4A shows extended portions of both the display element 400 and the touch-sensitive element 402, it will be understood that either or both the display element 400 or the touch-sensitive element 402 may be extended. For example, in some cases, only the display element 400 extends along the curved transition region 146 and the bezel region 112 (and may be adhered to or otherwise contact the interior surface of the front cover 122). As another example, in some cases, only the touch-sensitive element 402 extends along the curved transition region 146 and the bezel region 112. Moreover, the extended portions 404, 406 do not need to extend fully to the end of the bezel region 112, nor do they need to extend the same distance as each other. For example, in some cases, the display element 400 extends along the curved transition region 146 and the bezel region 112, and the touch-sensitive element 402 extends along the curved transition region 146 but does not extend into the bezel region 112. As another example, in some cases, the display element 400 extends along the curved transition region 146 but does not extend into the bezel region 112, and the touch-sensitive element 402 extends along the curved transition region 146 and into the bezel region 112. In any of the above examples, masks may be provided along portions of the curved transition region 146 and the bezel region 112 to define glyphs, icons, images, graphical output regions, or the like, in those regions.

The various combinations of extended display and touch-sensitive elements facilitate a variety of input and output functionalities along the curved transition region 146 and the bezel region 112. For example, a device that includes touch-sensing and display functionalities along the bezel region 112 may display input elements (e.g., buttons, icons, sliders, text input fields) in the bezel region 112, and detect touch-based inputs to the input elements (e.g., taps, presses, gestures, etc.). As another example, a device that includes display functionality (without touch-sensitivity) along the curved transition region 146 may produce graphical outputs along the curved transition region, such as status indicators, illuminated borders and/or boundaries, and the like.

In some cases, a particular appearance and/or tactile feel of the curved transition region 146 and the bezel region 112 may be achieved using masks (e.g., opaque masks), surface textures, surface coatings, or combinations of these (or other) treatments. FIG. 4B depicts a partial cross-sectional view of the front cover 122 and the display 103 (shown as a touch-sensitive display), showing a mask 408 extending along the curved transition region 146 and the bezel region 112 on the interior side of the front cover 122. The mask 408 may be an opaque mask that renders the front cover 122 opaque in those areas. The mask 408 may define openings that define glyphs, icons, status indicators, or the like. The openings may also correspond to areas in the curved transition region 146 and/or the bezel region 112 where the display element 400 and/or the touch-sensitive element 402 extend. For example, the mask 408 may define an opening where a selectable element is displayed by the extended portion 404 of the display and on which inputs are detected by the extended portion 406 of the touch-sensitive element. The mask 408 may include one or more layers of material. The materials may include ink, paint, dyes, deposited coating layers (e.g., produced via chemical vapor deposition, plasma vapor deposition, etc.), metal or metallic layers, or the like. While FIG. 4B shows the mask 408 extending along the entire curved transition region 146 and bezel region 112, it will be understood that the mask 408 may only extend along portions of these regions (e.g., only along the bezel region 112, only along the curved transition region 146 and a portion of the bezel region 112, or other distributions).

FIG. 4B also illustrates a surface texture 410 formed along the curved transition region 146 and the bezel region 112 on the exterior side of the front cover 122. The surface texture 410 may be used to provide visual and/or tactile features. For example, the surface texture 410 may produce a frosted or translucent appearance to the front cover 122, which may be used alone or with a mask 408 to occlude internal components and/or structures behind the front cover 122. In examples where a touch-sensitive element extends along the curved transition region 146 and/or the bezel region 112, the surface texture 410 may provide a certain tactile sensation when that touch-sensitive region is touched. In some cases, the surface texture 410 may reduce the friction or the sensation of friction between the touch-sensitive region and a user's finger. The surface texture 410 may also define discrete input regions, such as by defining non-textured regions (e.g., resembling holes in the surface texture) in which graphical elements (e.g., from a display or from a static graphic) may be presented, or by defining discrete textured regions (e.g., resembling textured buttons) that define user touch-sensitive input regions. While the surface texture 410 is shown on the exterior surface of the front cover 122, a surface texture may instead or additionally be defined along the interior surface of the front cover 122. The surface texture 410 may be produced via any suitable texturing technique, including but not limited to chemical etching, machining, abrasive blasting, fusion-base techniques (e.g., fusing a glass powder or frit to the front cover 122), or molding.

Surface textures and masks may be used together or independently. For example, a front cover 122 may include only a mask 408, only a surface texture 410, or both a mask 408 and a surface texture 410. Moreover, masks and surface textures may be defined along the exterior surface of the front cover 122, the interior surface of the front cover 122, or both. In some cases, masks and surface textures are used in conjunction to define user input regions, graphics, graphical output regions, or the like. For example, the surface texture 410 may define a non-textured region in the bezel region 112 that coincides with an opening in the mask 408. The extended portion of the display may display graphical outputs (e.g., corresponding to selectable user input elements) in that region, and the extended portion of the touch-sensitive element may detect user inputs applied in that region. As another example, the surface texture 410 may define a series of discrete non-textured regions, and the mask 408 may define glyphs (e.g., status icons for the device), which can be illuminated by a light source within the lid portion 102 (e.g., an extended portion of the display, a separate light source, etc.).

In some cases, the front cover 122 may define opaque or translucent regions within the bulk of the material of the front cover 122. FIG. 4C depicts a partial cross-sectional view of the front cover 122 and the display 103 (shown as a touch-sensitive display), showing an example in which the front cover 122 has a non-transparent region 412 extending along the curved transition region 146 and the bezel region 112. The non-transparent region 412 may be translucent or opaque and may be formed by fusing a non-transparent glass material to the transparent glass that defines the concave region 110 (and the display region). The non-transparent glass material may be fused before, after, or during a molding process that produces the overall convex configuration of the front cover 122. In some cases, the non-transparent region 412 may be formed by fusing a different type of material to the glass material that defines the concave region 110. For example, the concave region 110 may be defined by a glass material, and the non-transparent region 412 may be defined by a non-glass material (e.g., ceramic, zirconia, sapphire, etc.). Whether glass or a different material, the material that defines the non-transparent region 412 may be coupled to the glass material of the concave region 110 via diffusing bonding.

In some cases, some or all of the front cover 122 may be formed from a material other than glass (e.g., glass-ceramic, ceramic, polymer, etc.). In an example where the front cover 122 is formed from a polymer material, the concave region 110 may be formed from a transparent polymer and the non-transparent region 412 (e.g., corresponding to the curved transition region 146 and the bezel region 112) may be formed from a non-transparent polymer.

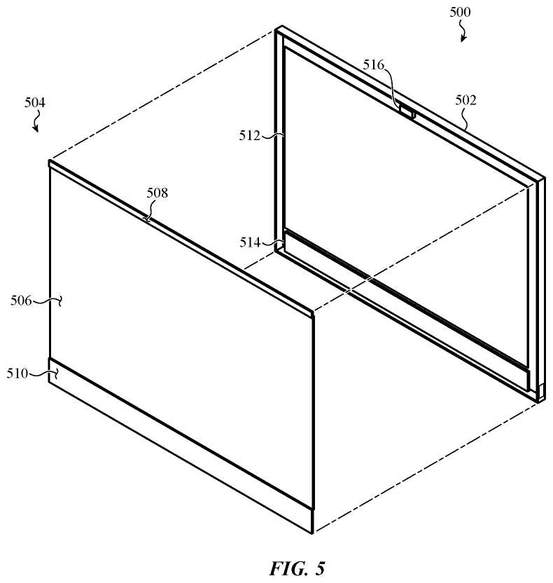

The foregoing figures illustrate an example front cover in which the concave region 110 is surrounded on four sides by the bezel region 112. In some examples, a shaped glass front cover defines bezel regions (e.g., raised or non-recessed border regions) along less than all of the sides of a concave region. FIG. 5, described below, illustrates an example front cover 504 with bezel regions along an upper and lower side of the concave display region.

FIG. 5 depicts a partial exploded view of a lid portion 500, showing the front cover 504 removed from a housing structure 502. The housing structure 502 may correspond to or be an embodiment of the housing structure 120. The lid portion 500 may also include a display 512 (which may correspond to or be an embodiment of the display 103), a circuit board assembly 514 (which may correspond to or be an embodiment of circuit board assembly 142), and a camera 516 (which may correspond to or be an embodiment of the camera 105).

The front cover 504 defines a concave region 506, an upper bezel region 508, and a lower bezel region 510. Similar to the front cover 122, the concave region 506 of the front cover 504 may be positioned over the display 512 and may define a display region of the lid portion 500. The concave region 506 may be recessed in a manner that reduces or minimizes empty space in the display region of the lid portion 500. Further, the concave region 506 may be configured to receive a convex region of a base portion therein, in the same or similar manner described with respect to the front cover 122.

The bezel regions 508, 510 may extend proud of the concave region 506, and may conform to the size of or otherwise accommodate components such as the circuit board assembly 514 and the camera 516, in the same or similar manner described with respect to the front cover 122. Front covers may be provided with proud bezel regions in various different arrangements along the sides of a concave region. For example, a front cover may define only an upper bezel region, or only a lower bezel region. In yet other examples, a front cover may define bezel regions along one or both of the lateral sides of the concave region. In yet other examples, a front cover may define three bezel regions, including both lateral sides and either the upper or lower bezel region.

The front cover 504 may be formed of the same materials and using the same techniques described with respect to the front cover 122 and may also define a curved transition region between the concave region 506 and the bezel regions 508, 510.

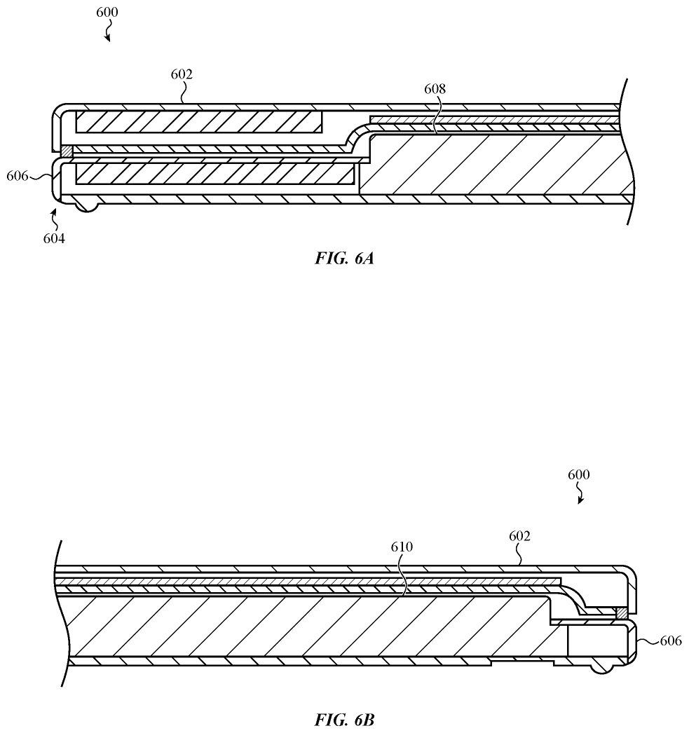

As described above, a base portion may define a convex region that includes or is at least partially defined by a keyboard and a trackpad that extend above (e.g., are proud of) a peripheral region of the base portion. In some cases, a curved transition region extends around all or a portion of the convex region and at least partially defines the convex region and/or the boundary of the convex region. In some cases, the curved transition region is omitted. FIGS. 6A-6B illustrate an example device 600 (e.g., a laptop computer) in which the base portion does not define a curved transition region.

FIG. 6A illustrates a detail view of a device 600, similar to the detail view of FIG. 3B, proximate a back side of the device 600, and FIG. 6B illustrates a detail view of the device 600, similar to the detail view of FIG. 3C, proximate a front side of the device 600. The lid portion 602 may correspond to the lid portion 102, and the description of the components of the lid portion 102 apply equally to the lid portion 602. The base portion 604 may correspond to the base portion 104, except that the top member 606 does not define a curved transition region around the convex region. Rather, the convex region is defined by the keyboard 608 and the trackpad 610, which extend proud of the upper surface of the top member 606 (e.g., the surface of the peripheral region of the top member 606). The keyboard 608 and the trackpad 610 may extend into the concave region of the front cover of the lid portion 602 in the same or similar manner as described with respect to the device 100.

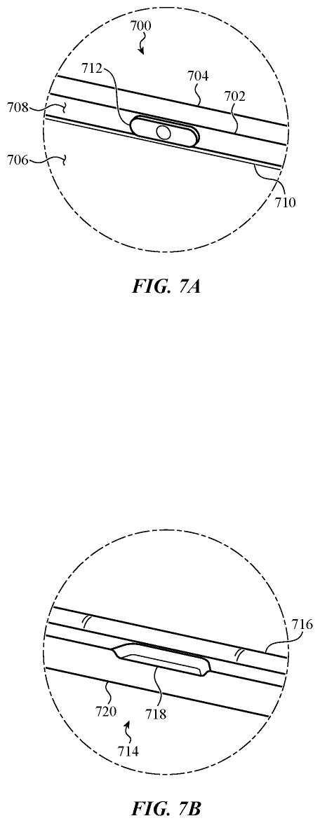

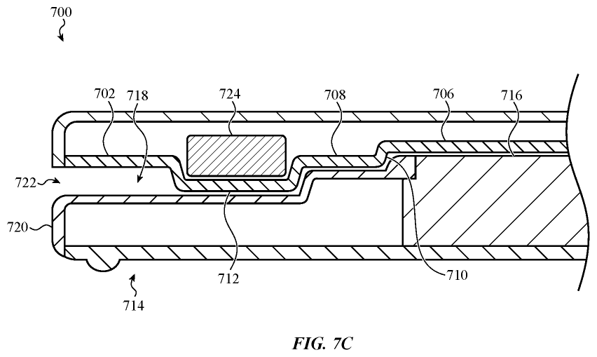

As described herein, the concave shape of the front cover defines a bezel region that defines a larger volume in the lid portion outside of the concave display region. In this way, the added thickness of components such as cameras and circuit board assemblies that are in the lid portion may be accommodated without having to increase the thickness of the lid over the display. In some cases, the bezel region of a front cover may include additional shapes and/or contours that further tailor the volume and thickness of the lid portion for various components. For example, FIGS. 7A-7C illustrate an example lid portion 700 in which a camera protrusion 712 is defined in the bezel region to accommodate a camera within the lid portion without requiring a global increase in thickness of the lid portion.

FIG. 7A is a detail view of an example lid portion 700, which may generally correspond to the area of a lid portion shown in area 7A-7A in FIG. 1A (though the exact configuration of the components may differ). FIG. 7B is a detail view of an example base portion 714, which may generally correspond to the area of a base portion shown in area 7B-7B in FIG. 1A (though the exact configuration of the components may differ). FIG. 7C is a partial cross-sectional view of a device (e.g., a laptop computer) with the lid portion 700 and the base portion 714, generally corresponding to a view along line 7C-7C in FIG. 1B (though the exact configuration of the components may differ).

With reference to FIG. 7A, the lid portion 700 may correspond to or be an embodiment of the lid portion 102. The lid portion 700 may include a front cover 702 (which may correspond to or be an embodiment of the front cover 122) and a housing structure 704 (which may correspond to or be an embodiment of the housing structure 120).

The front cover 702 defines a concave region 706, a bezel region 708, and a curved transition region 710 (which may generally correspond to the bezel regions, concave regions, and curved transition regions of other front covers described herein). The front cover 702 further defines, in the bezel region 708, a protrusion 712. The protrusion 712 may be configured to accommodate a camera 724 (FIG. 7C) in the volume defined between the protrusion 712 and the housing structure 704, as shown in FIG. 7C. The front cover 702 may be formed to define the protrusion 712 using the same types of operations for forming the overall concave shape of the front cover 702. For example, the protrusion 712 may be formed using a molding process (e.g., slumping) to form a continuous glass (or other material) structure that defines the concave region, the bezel region, the protrusion, and any curved and/or continuous transitions between these regions.

As described herein, the concave region 706 of the front cover 702 may nest with a convex region of a base portion of a device when the device is closed. This nesting arrangement allows the thicker areas of the base portion (e.g., where the keyboard and trackpad are) to nest into the thinner area of the lid portion (e.g., where the display is), thus reducing the thickness of the device and eliminating or reducing wasted or unused volume in the device housing. A similar nesting configuration may be provided for the protrusion 712 as well. For example, FIG. 7B illustrates a base portion 714 that defines a recess feature 718 into which the protrusion 712 may nest.

With reference to FIG. 7B, the base portion 714 may correspond to or be an embodiment of the base portion 104. The base portion 714 may include a top member 720 (which may correspond to or be an embodiment of the top member 130). The base portion 714 may also include a trackpad 716 (which may correspond to or be an embodiment of the trackpad 116) along a top side of the top member 720, and positioned in or at least partially defining a convex region of the base portion 714.

The top member 720 of the base portion 714 (which may also define one or more side surfaces of the base portion), may include a recess feature 718 defined along a front edge of the base portion 714. The recess feature 718 may define a gap 722 (FIG. 7C) between the base portion 714 and the lid portion 700 when the device is in the closed configuration, as shown in FIG. 7C. The gap 722 may provide a handle-like area to assist a user in opening the device. For example, the gap 722 may expose an edge of the lid portion so that a user's finger can more easily engage the edge to open the device.

The recess feature 718 may also accept the protrusion 712 when the device is in the closed configuration. For example, as shown in FIG. 7C, the protrusion 712 extends into the recess feature 718 when the device is in the closed configuration, in a manner similar to the nesting arrangement between the concave display region 706 and the convex region of the base portion 714 (e.g., including the trackpad 716). The protrusion 712 may only partially occupy the recess feature 718, such that the gap 722 remains exposed when the device is closed to allow a user to easily engage the lid to open the device.

As described above, the front cover 702 may be formed of glass or another transparent material, and as such may define a protective transparent window or cover over the camera 724. A mask along the interior of the front cover 702 in the bezel region may define a transparent window region for the camera 724. In some cases, a separate cover member (e.g., formed from glass, sapphire, glass-ceramic, etc.) may be provided in a hole formed through the front cover 702 in the bezel region to define a transparent window region for the camera 724. The cover member may have a different thickness than the bezel region of the front cover 702 (e.g., it may be thinner to accommodate a larger camera), and it may be formed of a different material (e.g., a sapphire cover member positioned in a hole in a glass front cover).

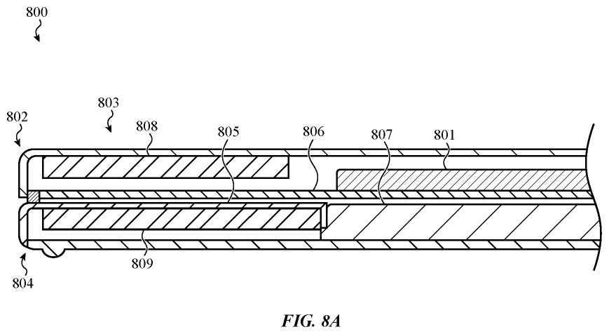

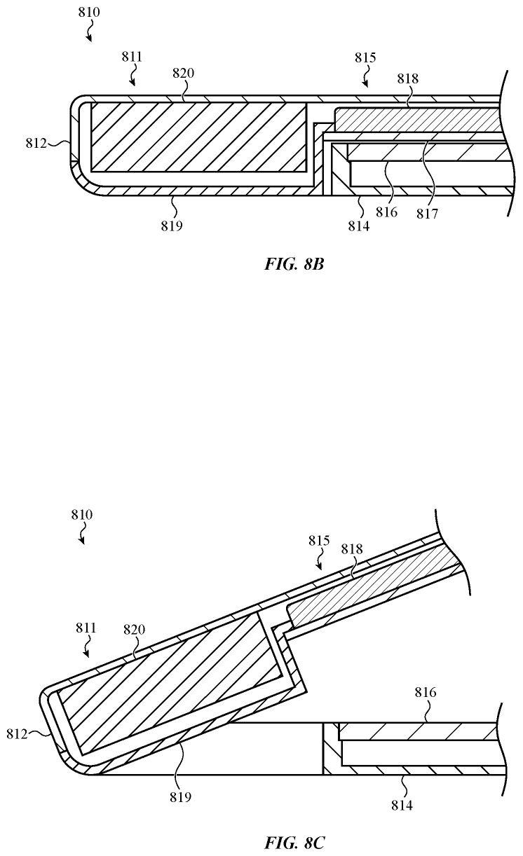

FIG. 8A depicts a partial cross-sectional view of an example device 800 (generally corresponding to the same view of a device as shown in FIGS. 3B and 6A), illustrating an example in which the circuit board assemblies of the lid and base portions are arranged in the manner similar to the device 100, but in which the lid and base portions do not define a nesting arrangement. For example, the device 800 includes a lid portion 802 and a base portion 804. The lid portion includes a front cover 806, which may define a substantially planar front exterior surface, and which may cover a display 801 and a first circuit board assembly 808. The first circuit board assembly may be positioned in a lower bezel region 803 of the lid portion 802 (e.g., along a bottom side of the display 801). The base portion 804 includes a second circuit board assembly 809 positioned in a peripheral region 805 between a keyboard 807 and a back of the device 800 (e.g., where the lid portion 802 joins the base portion 804 via a hinge mechanism). As shown, and similar to the device 100, the first circuit board assembly 808 and the second circuit board assembly 809 do not overlap the display 801 and the keyboard 807, respectively. Accordingly, the lid portion 802 can be made thinner, as it does not need to accommodate the combined thickness of a stacked or overlapping display and circuit board assembly. Similarly, the base portion 804 can be made thinner, as it does not need to accommodate the combined thickness of a stacked or overlapping keyboard and circuit board assembly.

FIGS. 8B-8C depict partial cross-sectional views of another example device 810 (generally corresponding to the same view of a device as shown in FIGS. 3B and 6A) that may achieve a low overall thickness. In this example, the device 810 includes a lid portion 812 pivotally coupled to a base portion 814 (e.g., via a hinge mechanism). The lid portion may include a front cover 817 positioned in front of a display 818, and a bezel member 819 along a side of the front cover 817 (e.g., in and/or defining a lower bezel region 811).

The lid portion also includes a circuit board assembly 820, which may provide processing functionality for both the lid-mounted components (e.g., the display 818, a camera, etc.), as well as for base-mounted components (e.g., a keyboard 816, a trackpad). The circuit board assembly 820 may also include memory components and a processing element, and may be the main (and optionally sole) circuit board assembly in the device.

Because the circuit board assembly 820 combines the functions of the first and second circuit board assemblies of other devices described herein, the circuit board assembly 820 may have a relatively larger volume (and/or thickness) than other circuit board assemblies described herein. In order to accommodate the larger size of the circuit board assembly 820, the bezel region 811 of the lid portion 802 may be thicker than a display region 815. In some cases, the bezel region 811 defines the full or maximum thickness of the device. The differences in thickness between the bezel region 811 and the display region 815 result in a stepped configuration of the lid portion 812 that nests with the base portion 814. For example, when the device 810 is in the closed configuration (FIG. 8C), the base portion 814 is positioned in the recess defined by the thinner display region 815, and the bezel region 811 overlaps a side of the base portion 814.

By positioning the circuit board assembly 820 in the bezel region 811, the circuit board assembly 820 does not need to overlap other components of the device, such as the keyboard 816 or the display 818, therefore reducing the minimum achievable thickness of the device. Additionally, because the lid portion has regions of different thicknesses, and because the base portion 814 nests with the thinner region of the lid, the device 800 can accommodate the larger circuit board assembly 820 without incurring a corresponding increase in overall thickness.

FIGS. 8B-8C depict a lid portion 812 in which the bezel member 819 is a different structure than the front cover 817. In other examples, a single front cover may define both the display region 815 and the bezel region 811. For example, the front cover may be a single piece of shaped glass (e.g., formed via a molding process as described herein) that defines the bezel region 811 and the display region 815 that is recessed relative to the bezel region 811.

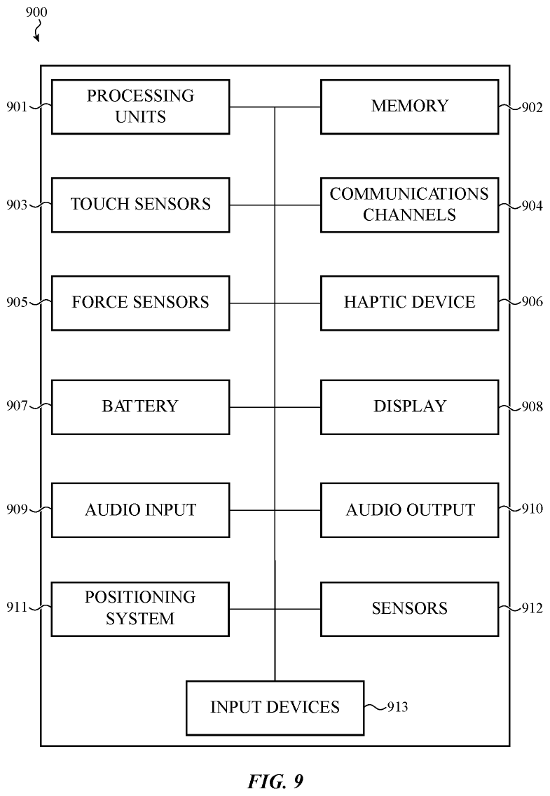

FIG. 9 depicts an example schematic diagram of an electronic device 900. The electronic device 900 may be an embodiment of or otherwise represent the devices 100, 600, 800, 810 (or other devices described herein). The device 900 includes one or more processing units 901 that are configured to access a memory 902 having instructions stored thereon. The instructions or computer programs may be configured to perform one or more of the operations or functions described with respect to the electronic devices described herein. For example, the instructions may be configured to control or coordinate the operation of one or more displays 908, one or more touch sensors 903, one or more force sensors 905, one or more communication channels 904, one or more audio input systems 909, one or more audio output systems 910, one or more positioning systems 911, one or more sensors 912, and/or one or more haptic feedback devices 906. Where the device 900 is a notebook computer, the components and/or systems described with respect to FIG. 9 may be included in the base portion of the device (e.g., the base portion 104), the lid portion of the device (e.g., the lid portion 102), or distributed between the base portion and the lid portion.

The processing units 901 of FIG. 9 may be implemented as any electronic device capable of processing, receiving, or transmitting data or instructions. For example, the processing units 901 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 902 can store electronic data that can be used by the device 900. For example, a memory can store electrical data or content such as, for example, audio and video files, images, documents and applications, device settings and user preferences, programs, instructions, timing and control signals or data for the various modules, data structures or databases, and so on. The memory 902 can be configured as any type of memory. By way of example only, the memory can be implemented as random access memory, read-only memory, Flash memory, removable memory, or other types of storage elements, or combinations of such devices.

The touch sensors 903 may detect various types of touch-based inputs and generate signals or data that are able to be accessed using processor instructions. The touch sensors 903 may use any suitable components and may rely on any suitable phenomena to detect physical inputs. For example, the touch sensors 903 may be capacitive touch sensors, resistive touch sensors, acoustic wave sensors, or the like. The touch sensors 903 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 903 may be integrated with or otherwise configured to detect touch inputs applied to any portion of the device 900. For example, the touch sensors 903 may be configured to detect touch inputs applied to any portion of the device 900 that includes a display (and may be integrated with a display), such as the display 103. The touch sensors 903 may also be configured to detect touch inputs applied to a trackpad, such as the trackpad 116. The touch sensors 903 may operate in conjunction with the force sensors 905 to generate signals or data in response to touch inputs. A touch sensor or force sensor that is positioned over a display surface or otherwise integrated with a display may be referred to herein as a touch-sensitive display, force-sensitive display, or touchscreen.

The force sensors 905 may detect various types of force-based inputs and generate signals or data that are able to be accessed using processor instructions. The force sensors 905 may use any suitable components and may rely on any suitable phenomena to detect physical inputs. For example, the force sensors 905 may be strain-based sensors, piezoelectric-based sensors, piezoresistive-based sensors, capacitive sensors, resistive sensors, or the like. The force sensors 905 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 905 may be used in conjunction with various input mechanisms to detect various types of inputs. For example, the force sensors 905 may be used to detect presses or other force inputs that satisfy a force threshold (which may represent a more forceful input than is typical for a standard “touch” input). Like the touch sensors 903, the force sensors 905 may be integrated with or otherwise configured to detect force inputs applied to any portion of the device 900. For example, the force sensors 905 may be configured to detect force inputs applied to any portion of the device 900 that includes a display (and may be integrated with a display), such as the display 103. The force sensors 905 may also detect force inputs applied to trackpads, such as the trackpad 116. The force sensors 905 may operate in conjunction with the touch sensors 903 to generate signals or data in response to touch- and/or force-based inputs.

The device 900 may also include one or more haptic devices 906. The haptic device 906 may include one or more of a variety of haptic technologies such as, but not necessarily limited to, rotational haptic devices, linear actuators, piezoelectric devices, vibration elements, and so on. In general, the haptic device 906 may be configured to provide punctuated and distinct feedback to a user of the device. More particularly, the haptic device 906 may be adapted to produce a knock or tap sensation and/or a vibration sensation. Such haptic outputs may be provided in response to detection of touch and/or force inputs and may be imparted to a user through the exterior surface of the device 900 (e.g., via a glass or other surface that acts as a touch- and/or force-sensitive display or surface). The haptic device 906 may provide haptic outputs in response to key inputs applied to a virtual (e.g., touchscreen based) keyboard, and/or to inputs applied to a trackpad. A touchscreen-based keyboard may be provided on an upper surface of a base portion of a device (e.g., the base portion 104).

The one or more communication channels 904 may include one or more wireless interface(s) that are adapted to provide communication between the processing unit(s) 901 and an external device. The one or more communication channels 904 may include antennas (e.g., antennas that include or use the housing components as radiating members), communications circuitry, firmware, software, or any other components or systems that facilitate wireless communications with other devices. In general, the one or more communication channels 904 may be configured to transmit and receive data and/or signals that may be interpreted by instructions executed on the processing units 901. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces, TCP/IP interfaces, network communications interfaces, or any conventional communication interfaces. The one or more communications channels 904 may also include ultra-wideband (UWB) interfaces, which may include any appropriate communications circuitry, instructions, and number and position of suitable UWB antennas.

As shown in FIG. 9, the device 900 may include a battery 907 that is used to store and provide power to the other components of the device 900. The battery 907 may be a rechargeable power supply that is configured to provide power to the device 900. The battery 907 may be coupled to charging systems (e.g., wired and/or wireless charging systems) and/or other circuitry to control the electrical power provided to the battery 907 and to control the electrical power provided from the battery 907 to the device 900.

The device 900 may also include one or more displays 908 configured to display graphical outputs. The displays 908 may use any suitable display technology, including liquid crystal displays (LCD), organic light emitting diodes (OLED), active-matrix organic light-emitting diode displays (AMOLED), or the like. The displays 908 may display graphical user interfaces, images, icons, or any other suitable graphical outputs. The display 908 may correspond to the display 103 or other displays described herein.

The device 900 may also provide audio input functionality via one or more audio input systems 909. The audio input systems 909 may include microphones, transducers, or other devices that capture sound for voice calls, video calls, audio recordings, video recordings, voice commands, and the like.

The device 900 may also provide audio output functionality via one or more audio output systems (e.g., speakers) 910. The audio output systems 910 may produce sound from voice calls, video calls, streaming or local audio content, streaming or local video content, or the like.

The device 900 may also include a positioning system 911. The positioning system 911 may be configured to determine the location of the device 900. For example, the positioning system 911 may include magnetometers, gyroscopes, accelerometers, optical sensors, cameras (e.g., the front-facing cameras 105, 516, 724), global positioning system (GPS) receivers, inertial positioning systems, or the like. The positioning system 911 may be used to determine spatial parameters of the device 900, such as the location of the device 900 (e.g., geographical coordinates of the device), measurements or estimates of physical movement of the device 900, an orientation of the device 900, or the like.

The device 900 may also include one or more additional sensors 912 to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensors (e.g., fingerprint sensors, photoplethysmographs, blood-oxygen sensors, blood sugar sensors, or the like), eye-tracking sensors, retinal scanners, humidity sensors, buttons, switches, lid-closure sensors, or the like.

The device 900 may also include one or more input devices 913. An input device 913 is a device that is configured to receive user input. The input devices 913 may include, for example, a keyboard (touchscreen based or mechanical), a trackpad or other pointing device, a push button, a touch-activated button, a keypad, or the like. In some embodiments, the input device 913 may provide a dedicated or primary function, including, for example, a power button, volume buttons, home buttons, scroll wheels, and camera buttons. Generally, a touch sensor (e.g., a touchscreen) or a force sensor may also be classified as an input device. However, for purposes of this illustrative example, touch sensors and force sensors are depicted as distinct components within the device 900.

To the extent that multiple functionalities, operations, and structures described with reference to FIG. 9 are disclosed as being part of, incorporated into, or performed by the device 900, it should be understood that various embodiments may omit any or all such described functionalities, operations, and structures. Thus, different embodiments of the device 900 may have some, none, or all of the various capabilities, apparatuses, physical features, modes, and operating parameters discussed herein. Further, the systems included in the device 900 are not exclusive, and the device 900 may include alternative or additional systems, components, modules, programs, instructions, or the like, that may be necessary or useful to perform the functions described herein.

As described above, one aspect of the present technology is the gathering and use of data available from various sources to improve the usefulness and functionality of devices such as mobile phones. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate devices, deliver targeted content that is of greater interest to the user, or the like. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

What is claimed is:

1. A laptop computer comprising:
a lid portion comprising:
a housing structure;
a glass cover positioned coupled to the housing structure and defining a concave region; and
a display positioned below the concave region of the glass cover; and
a base portion positionable in a closed configuration and an open configuration with respect to the lid portion and defining a convex region along a top side of the base portion, the convex region configured to extend into the concave region of the glass cover when the lid portion and the base portion are in the closed configuration, the base portion comprising a keyboard positioned at the convex region.

2. The laptop computer of claim 1, wherein:
the glass cover is a unitary glass structure;
the lid portion is coupled to the base portion by a hinge;
the keyboard comprises a plurality of physical keys; and
the base portion further comprises a trackpad positioned at the convex region.

3. The laptop computer of claim 1, wherein:
the concave region defines a display region of the lid portion; and
the glass cover further defines:
a bezel region extending around a periphery of the display region; and
a curved transition region extending from the bezel region to the display region.

4. The laptop computer of claim 3, wherein:
the curved transition region is a first curved transition region; and
the base portion comprises a top member defining:
the convex region;
a peripheral region extending around a periphery of the convex region; and
a second curved transition region extending from the peripheral region to the convex region.

5. The laptop computer of claim 1, wherein:
the base portion comprises a glass top member; and
the glass top member at least partially defines the convex region.

6. The laptop computer of claim 5, wherein the glass top member defines, at the convex region, a trackpad.

7. The laptop computer of claim 6, wherein the glass top member further defines, at the convex region, a virtual keyboard.

8. A portable computing device comprising:
a lid portion comprising:
a housing structure;
a unitary glass cover coupled to the housing structure and defining:
a bezel region; and
a recessed region at least partially surrounded by the bezel region; and
a display positioned below the recessed region; and
a base portion flexibly coupled to the lid portion and comprising:
a keyboard protruding from a top surface of the base portion and configured to extend into the recessed region when the lid portion and the base portion are in a closed configuration; and
a trackpad protruding from the top surface of the base portion and configured to extend into the recessed region when the lid portion and the base portion are in the closed configuration.

9. The portable computing device of claim 8, wherein:
the lid portion is coupled to the base portion via a hinge mechanism positioned along a bottom side of the lid portion and a back side of the base portion; and
the portable computing device further comprises:
a first circuit board assembly in the lid portion and positioned between the recessed region and the hinge mechanism; and
a second circuit board assembly in the base portion and positioned between the keyboard and the hinge mechanism.

10. The portable computing device of claim 8, wherein the first circuit board assembly is non-overlapping with an active area of the display.

11. The portable computing device of claim 10, wherein the second circuit board assembly is non-overlapping with the keyboard.

12. The portable computing device of claim 8, wherein:
the base portion comprises a unitary glass top member;
the keyboard is a virtual keyboard; and
the unitary glass top member defines a surface of the virtual keyboard and a surface of the trackpad.

13. The portable computing device of claim 8, wherein:
the bezel region is opaque; and
the recessed region is transparent.

14. The portable computing device of claim 12, further comprising an opaque mask positioned in the bezel region along an interior surface of the unitary glass cover.

15. A portable computing device comprising:
a lid portion comprising:
a housing;
a display at least partially within the housing;
a unitary glass cover positioned over the display and defining:
a bezel region extending at least partially around an active area of the display; and
a recessed display region recessed relative to the bezel region and positioned over the active area of the display; and
a circuit board assembly positioned below a portion of the bezel region and conductively coupled to the display; and
a base portion flexibly coupled to the lid portion and comprising a keyboard protruding from a top surface of the base portion and configured to extend into the recessed display region when the lid portion and the base portion are in a closed configuration.

16. The portable computing device of claim 15, wherein the lid portion further comprises a touch sensing system configured to detect touch inputs applied to the recessed display region and at least a portion of the bezel region.

17. The portable computing device of claim 15, further comprising a camera positioned in the bezel region.

18. The portable computing device of claim 15, wherein:
the circuit board assembly is a first circuit board assembly; and
the base portion comprises a second circuit board assembly conductively coupled to the first circuit board assembly.

19. The portable computing device of claim 18, wherein:
the base portion is flexibly coupled to the lid portion via a hinge mechanism positioned along a bottom of the lid portion and a back of the base portion; and
the second circuit board assembly is positioned within the base portion between the keyboard and the hinge mechanism.

20. The portable computing device of claim 19, wherein:
the keyboard is positioned in a keyboard region of the base portion;
the first circuit board assembly is positioned entirely outside the recessed display region; and
the second circuit board assembly is positioned entirely outside the keyboard region.
